(19) United States
(12) Patent Application Publication
(10) Pub. No.: US 2006/0212696 A1
(43) Pub. Date: Sep. 21, 2006

(54) Method and system for selective information delivery in a rich client form

(76) Inventors: Leugim A. Bustelo, Austin, TX (US); Andrew Douglas Hately, Austin, TX (US); Julio Eloy Ruano, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(21) Appl. No.: 11/082,702

(22) Filed: Mar. 17, 2005

(51) Int. Cl. H04L 9/00

(52) U.S. Cl. 713/150

(57) ABSTRACT

The present invention is directed to a method and system for delivering user selective information from a rich client to multiple parties through a single GUI. Rich client interfaces may be designed to submit information to multiple destinations, targeting to access multiple web services. In the present invention, users of the client interface may be informed about parties to whom they are submitting information. An enhanced user interface may include various visual indicators on each input field, which may provide information about the party receiving the input field. The rich client may validate each party before the information is sent. Selective information through a user interaction at the client side may be delivered from the client to the multiple parties.

### FIELD OF THE INVENTION

The present invention generally relates to the field of rich client applications, and particularly to an enhanced user interface for selective information delivery through rich client forms.

### BACKGROUND OF THE INVENTION

With a client-server application, there is a wide spectrum of implementations from thick (fat) client to thin client. Recently, interest has been building in the idea of a “rich client” which is considered a robust, responsive and visually interesting user interface. An extreme fat client downloads the entire application and only calls the server when data needs to be exchanged. Thus, the entire user interface along with all application logic resides on the client (user's machine). At the other extreme, a thin client downloads only a small parcel of data with a minimal user interface. A thick (fat) client application provides enhanced performance without burdening a server but the performance may come at the expense of a significant initial download and installation. Further, any changes to the application require a time/resource consuming upgrade across the clients. In addition, thick clients are not built on frameworks as open as traditional Web applications. Thin client applications allow ease of development, deployment, and upgrading however, the user usually suffers from the delayed client-server communications since the server is in charge of data manipulation, invoking events and the like. The rich client lies in the middle of these two extremes.

Some rich client interfaces may be designed to submit information to multiple destinations, targeting to access multiple web services. In such a case, users of the client interface may not know about parties to whom they are submitting information. One example may be a multi-party electronic health form. Currently, electronic forms (GUI) equivalent to the paper forms used in the health care industry are utilized. One electronic form may replace several paper forms since some information is repeated on each form submitted to various parties (in health care system, parties may include a billing department, a health insurance company, an administration department, doctors, and the like). For example, name and patient number may be required for every form in health care system. Health insurance information may be required for the billing department and the health insurance company. Conventionally, the several forms are often merged in to one graphic user interface so that users may input information at once for multiple parties. Each piece of information may be sent to one or more parties by invoking several remote services. However, the end user may not be informed about which piece of information goes to which party. Thus, the end user may not be able to determine which party can receive certain sensitive and private information such as a social security number, a medical history, a marital status and the like.

Therefore, it would be desirable to provide a GUI allowing a user to determine which information is viewable by a particular party. It would be also desirable to provide a method for providing the user with identity and security information of the particular party which will receive sensitive and private information.

### SUMMARY OF THE INVENTION

Accordingly, the present invention provides an enhanced user interface for selective information delivery to multiple parties through rich client forms.

In a first aspect of the present invention, a method for delivering user selective information from a rich client to multiple destinations is provided. An electronic form may be encoded with addresses of endpoints (parties). Each endpoint may have a list of input fields with which it desires to receive information from the user. The list of input fields is created for associated endpoint. The form may be mapped to a graphic user interface in order to receive user input information. The graphic user interface may include input fields with visual indicators suitable for informing a user about various endpoints. Thus, before displaying the graphic user interface for a user to input information, the client may communicate with endpoints to obtain identity and security information. When the user selects a visual indicator on the input field, the visual indicator may provide security and identity information of the endpoint associated with the input field. The user may input selective information via the graphic user interface. Then, a customized form including necessary user information for each endpoint may be created. In parallel, each of the customized forms may be sent to a designated endpoint when the user desires to submit the form.

In a second aspect of the present invention, a method for delivering user selective information through a standardized policy declaration is provided. A form may be a secured document that contains identity information regarding which fields are shared with each receiving party. The form may be mapped to a graphic user interface representation with visual indicators. A different encryption key is created for each of endpoints. The encryption key may be attached to each input field which is allowed to be seen by the secured endpoints. The standard form containing encryption keys and received user inputs through the graphic user interface may be created. Then, the created standard form may be sent to multiple destinations when the user desires to submit the form. On the graphic user interface, visual indicators may be utilized for an input field in order to provide information of an associated endpoint of the input field. A list of addresses of the endpoints and the list of fields for a standard form may be provided from a server. Alternatively, a list of addresses of the endpoints and the list of fields for a standard form are downloaded from a server periodically.

In an advantageous aspect of the present invention, users of the client may be informed about the parties to whom they are submitting information through a single graphic user interface at the client side. Data exchanged between the client and the receiving parties may be reduced since a customized form without unnecessary information is sent to each receiving party.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a block diagram of a rich client interface system in accordance with an exemplary embodiment of the present invention;

FIG. 2 is an illustration of a flow diagram of a method implemented in accordance with an exemplary embodiment the present invention;

FIG. 3 is an illustration of a flow diagram of another method implemented in accordance with an exemplary-embodiment the present invention;

FIG. 4 is an illustration of a graphic user interface utilized in an exemplary embodiment of the present invention; and

FIG. 5 is an illustration of an exemplary message box utilized in the graphic user interface in FIG. 4 in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

The present invention is directed to a method and system for delivering user selective information from a rich client to multiple parties through a single GUI. The rich client interface may be designed to submit information to multiple destinations, targeting to access multiple web services. In the present invention, users of the client interface may be informed about parties to whom they are submitting certain information. An enhanced user interface may include various visual indicators on each input field, which may provide information about the party receiving the input field. The rich client may authenticate each party before sending the information to the parties. Selective information through a user interaction at the client side may be delivered from the client to the multiple parties. In the following description, numerous specific descriptions are set forth in order to provide a thorough understanding of the present invention. It should be appreciated by those skilled in the art that the present invention may be practiced without some or all of these specific details. In some instances, well known process operations have not been described in detail in order not to obscure the present invention.

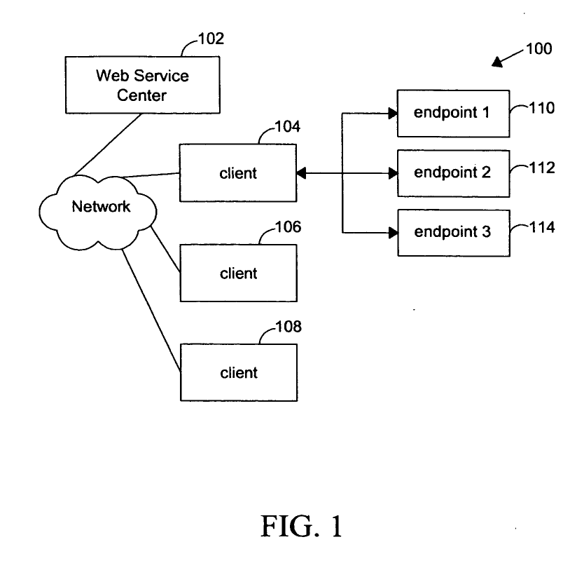

Referring generally now to FIGS. 1 through 5, exemplary embodiments of the present invention are shown.

In an embodiment of the present invention, a single GUI may be utilized to deliver user information from a rich client to multiple destinations (endpoints). Typically, the application on the client side handles the user interface and may provide program logic for processing user input. Additionally, a client application must match the requirements of a particular server to provide communications with the particular server. A graphical user interface (GUI) exists in the client to handle what the user views on the screen. Events resulting from user input, such as mouse clicks or keyboard strokes, are detected and handled through the GUI. Communication with the server is provided using processes that use protocols, such as hypertext transfer protocol (HTTP), secure sockets (SSL), or Remote Method Invocation (RMI).

Conventional client software can be either “thick” or “thin”. A thick client is typically a large client-installed application that may access a database directly and apply business logic. They may have dependence on the client operating system and require manual support to install and configure. By contrast, a thin client is typically a small application downloaded on request from a server and accesses the database through an intermediate application server. This is known as a multi-tier application. A number of different usage scenarios for clients are present, resulting in a variety of client needs being present.

At the other end of the spectrum, power users with high speed connections expect screen refresh times in the sub-second range and “instantaneous” echoing of typed characters to provide the look and feel of processing in a local environment. In a multi-tier computing environment, the primary role of the client is to present and gather information quickly. The client application is considered a business asset independent of the network topology and server function. In these environments, it is desirable to be able to use the same client processing code for different user types and interface channels, such as automated teller machines (ATM), Kiosks, Internet [hypertext markup language (HTML)/applets], and regional office clients (applications). The rich client lies in the middle of these two extremes.

It is to be noted that rich client applications are well known to the art. Generally, the rich client allows for more efficient use of the client machine. By using interactive components, enterprise and Web applications can behave more like desktop applications. Data may be sent to/from the server without having to reload the entire interface. Logic and data storage can be implemented on the client side. In the rich client environment, the server can focus attention on business logic and data handling and not a user interface. (UI) generation and manipulation. The Rich Clients are often combined with logic and data delivered from application servers, XML Web services, or the like.

Referring now to FIG. 1, an exemplary block diagram 100 of a rich client interface targeting to access multiple destinations (e.g. applications, web services, or the like) is shown. A Web Service Server 102 is communicatively coupled with various clients 104-108 through a network. For example, the Web Service Server 102 may provide logic and data for a client 104. Based on the received data, the client 104 may display a GUI suitable to receive user information. The client 104 may be able to process the user interaction and create a form containing selective user information for each of the endpoints 110-114. The individual form may be delivered from the client 104 to each of the endpoints 110-114.

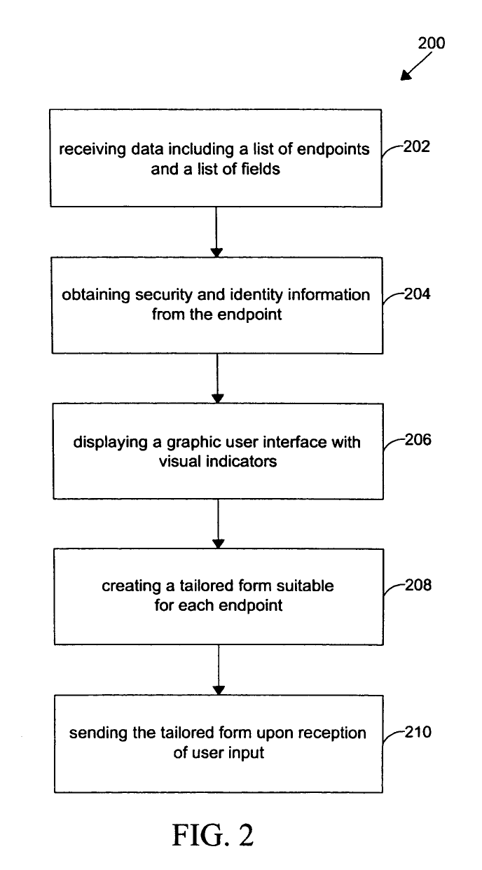

Referring now to FIG. 2, a flow diagram of a method implemented in an exemplary embodiment of the present invention is shown. In step 202, data with a list of endpoints and a list of fields may be received from a Web Service Server. The data may be specified in a particular message format. A particular transmission protocol will deliver the message to the server. The server accepts the message protocol as its application programming model (API) to its services and returns a result. A variety of software systems, such as Enterprise Java Beans (EJB), Servlets, Java Server Pages (JSP), and XML have been implemented to enhance the development of client and server-side software. It should be appreciated that the data can be exchanged through various protocols. The received data may be suitable for encoding a rich client form targeting to access multiple endpoints (web services). The list of endpoints may be a list containing a Uniform Resource Locator (URL) for each web service where the server requests the client to access. A URL includes a protocol identifier and a resource name (separated from the protocol identifier by a colon and two forward slashes). The protocol identifier indicates the protocol used to fetch the named resource. Examples of protocols include HTTP, FTP and the like. A form may be encoded with several endpoints and a list of fields which each endpoint desires to receive. This may be delivered from the Web Service Server.

Typically, a server and a client may exchange data with each other to implement rich client applications. For example, a client locates a Web Service Server and the Web Service Server provides logic and data with a dynamic set of user interface to the client. The set of user interface delivered to the client is “rich” in functionality. In other words, the client may be able to manipulate the data extensively without overloading the server. It will be appreciated that rich client applications can be implemented in various ways. It will be also appreciated that the rich client form may be mapped in a graphic user interface in order to receive user inputs at the client site.

In step 204, the client may communicate with each of the endpoints in order to obtain security and identity information. The client may maintain the obtained information in memory. In an embodiment of the present invention, each endpoint may have an associated list of input fields with which the each end point desires to receive user input. In step 206, a graphic user interface may be displayed. The user graphic interface may comprise visual indicators on each input field of the form which will be sent to the associated endpoint. The visual indicator may provide security and identity information of each endpoint or the like. The visual indicators may be overlaying colors on the input fields on the form. For example, each color may be associated with each endpoint. Alternatively, the visual indicators may be icons capable of providing detailed information of the endpoints.

In step 208, a customized form for each of the endpoints may be created. The customized form may have selective data from the list of input fields associated with the endpoint. Then, the customized forms may be sent to each designated endpoint from the client when the user selects a form submission request. In this manner, the user may provide information only once in a multi-party transaction with a knowledge of selective information delivery to receiving parties. The client may notify the Web Service Server of the form delivery.

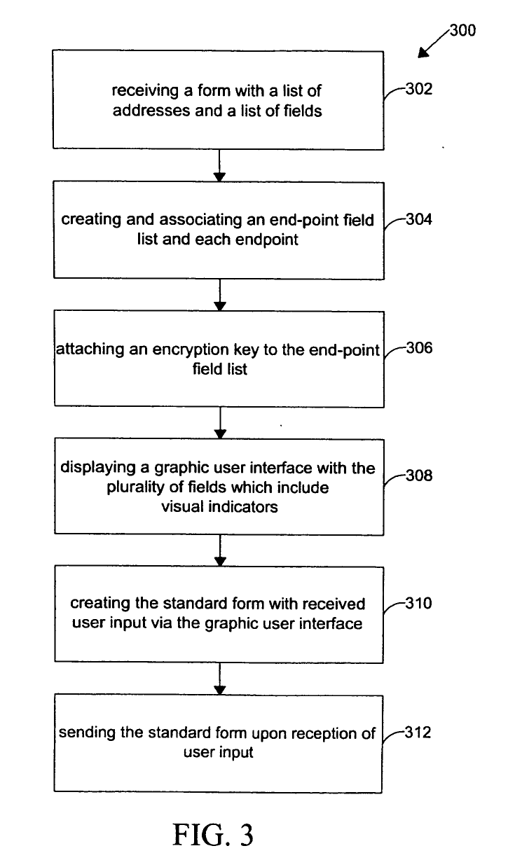

Referring now to FIG. 3, a flow diagram of another method utilizing standard policy declaration implemented in an exemplary embodiment of the present invention is shown. In an embodiment of the present invention, a secured document containing identity information regarding which fields are shared with each receiving party may be sent to multiple endpoints.

In step 302, a standard secured form with a list of endpoint and a list of input fields may be received from a server. Based on the received data from the server, an end-point field list may be created and associated with a receiving endpoint in the client side in step 304. The client may communicate with each of the endpoints to create a proper encryption code. Alternatively, the server may provide the encryption information of the endpoint. In step 308, the client may attach an encryption code to the end-point field list. The standard secured form may be mapped in to GUI representation comprising input fields. The input fields may include visual indicators to provide endpoint related information. An example of the visual indicators may be an icon capable of firing events. When the user clicks the icon on the GUI, the icon may provide identity, security information of the associated endpoint. In step 310, the client may create a standard form including all of the user input fields having encryption keys attached. In step 312, the created standard form may be sent to multiple destinations. Each endpoint may be able to see the selective fields that can be decrypted by the endpoint. In this manner, one form can be utilized but only selective information on the form may be accessible by a certain endpoint.

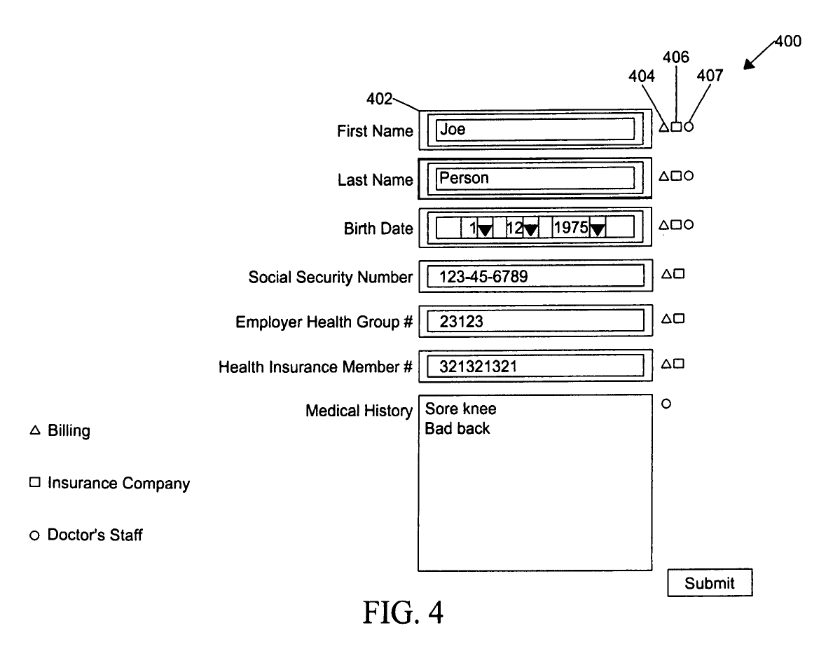

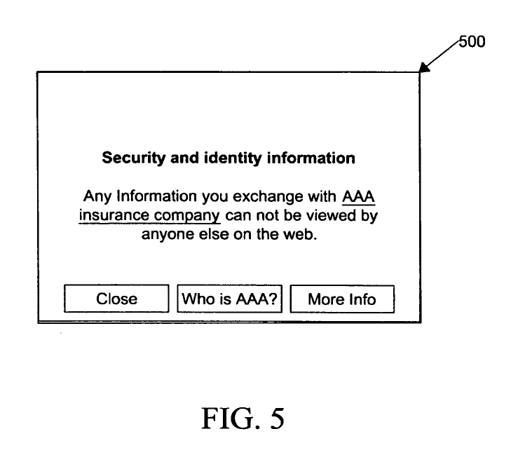

Referring to FIG. 4, an exemplary GUI 400 in accordance with the present invention is shown. The exemplary GUI 400 may display a rich client form for a Health Care Web Service. Paper forms required by a billing department, Insurance Company, and Doctor's office may be merged in to the GUI 400. Each input field may have visual indicators in order for a user to be aware of multiple destinations receiving the input field. When the user desires to know a declared policy of an endpoint associated with an input field, the user may obtain such information by selecting a visual indicator next to the input field. For example, the GUI 400 displays visual indicators 404-407 for a first name field 402. The visual indicators 404-407 in this example are icons for each endpoint (Billing, Insurance Company, Doctor's staff). Each icon 404-407 may provide information regarding the corresponding endpoint. For example, if the user clicks the icon 406, Icon 406 may invoke a message box including detail information of insurance company application. It will be appreciated that there are various way to provide additional information though visual indicators. Referring now to FIG. 5, an exemplary message box 500 in accordance with the present invention is shown. In an advantageous aspect of the present invention, the client is capable of manipulating GUI, being responsive to a user interaction, and creating/sending customized forms with/without connection with the Web Server.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the method and system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for delivering user selective information to multiple destinations, comprising:
receiving a form encoded with a plurality of endpoints and a plurality of fields;
obtaining security information from the plurality of endpoints;
displaying a graphic user interface with the plurality of fields, each of the plurality of fields containing information of the associated end point;
creating a customized form suitable for delivering selective information for each of the plurality of endpoints; and
sending the customized form upon reception of user input indicating the form submission.

2. The method as described in claim 1, further comprising:
associating a list of fields to each of the plurality of endpoints,
wherein the list of fields is created based on the plurality of fields.

3. The method as described in claim 1, wherein the security information is obtained through security handshaking.

4. The method as described in claim 1, wherein the each of the plurality of fields is associated with at least one of the plurality of endpoints.

5. The method as described in claim 1, wherein visual indicators are utilized to provide information of an associated endpoint of each input field on the graphic user interface.

6. The method as described in claim 5, wherein the information includes security information, identity information and association information.

7. The method as described in claim 4, wherein the visual indicator is coupled to a message box which explains the information in further detail.

8. The method as described in claim 1, further comprising:
obtaining identity information from the plurality of endpoints; and
displaying the identity information on the graphic user interface.

9. A method for delivering user selective information to multiple destinations wherein a standard form is sent to the multiple destination, comprising:
receiving a form encoded with a plurality of endpoints and a plurality of lists of fields;
associating each of the plurality of lists of fields and each of the plurality of endpoints;
attaching at least one encryption keys to each of the plurality of lists of fields,
wherein a different encryption key is created for each of the plurality of endpoints;
displaying a graphic user interface with the plurality of fields, each of the plurality of fields displaying information of the associated endpoints;
creating the standard form with received user input via the graphic user interface; and
sending the standard form upon reception of user input indicating the form submission.

10. The method as described in claim 9, wherein visual indicators are utilized to provide information of an associated endpoint of each of the plurality of the fields.

11. The method as described in claim 9, wherein appropriate encryption key is determined based on the endpoint.

12. The method as described in claim 9, wherein a list of addresses and the list of fields for a standard form are received from a server

13. The method as described in claim 10, wherein the information includes security information, identity information and association information.

14. The method as described in claim 10, wherein the visual indicator is coupled to a message box, the message box explaining the information in further detail.

15. The method as described in claim 9, further comprising:
obtaining identity information from the plurality of endpoints; and
displaying the identity information on the graphic user interface.

16. A system for delivering customized forms to multiple destinations in rich client applications, comprising:
means for receiving a logic and data from a server,
wherein data include a form, a plurality of endpoints and a plurality of fields being received by the endpoint;
means for creating and associating a list of fields to each of the plurality of endpoints;
means for obtaining security information from the plurality of endpoints,
wherein the security information is obtained through security handshaking;
means for displaying a graphic user interface with the plurality of fields, each of the plurality of fields having visual indicators suitable for displaying the security information of the associated endpoints;
means for creating a customized form suitable for delivering selective information to each of the plurality of endpoints; and
means for sending the customized form upon reception of user input indicating the form submission.

17. The system as described in claim 16, wherein the visual indicator is coupled to a message box, the message box explaining the visual indicator in detail.

18. The system as described in claim 16, further comprising:
obtaining identity information from the plurality of endpoints; and
displaying the identity information on the graphic user interface.
